(19) United States
(12) Patent Application Publication
(10) Pub. No.: US 2005/0018447 A1
(43) Pub. Date: Jan. 27, 2005

(54) Portable storing device with universal serial bus

(75) Inventors: Tiem-Shun Ma, Tucheng City (TW); Jao-ching Lin, Taoyuan City (TW); Chien-cheng Huang, Taoyuan (TW)

Correspondence Address: BACON & THOMAS, PLLC, 625 SLATERS LANE, FOURTH FLOOR, ALEXANDRIA, VA, 22314, US

(73) Assignee: ASIA VITAL COMPONENTS CO., LTD., Kaohsiung (TW)

(21) Appl. No.: 10/625,560

(22) Filed: Jul. 24, 2003

(51) Int. Cl. F21V 7/04

(52) U.S. Cl. 362/555

(57) ABSTRACT

A portable storing device with universal serial bus (USB) includes a housing being provided at a predetermined position with a through hole having an outer mask fitted therein; a housing cap being closed to an open end of the housing; and a storage unit being located in an inner space defined between the housing and the housing cap, and including a storage circuit board, a light emitting diode (LED), and a USB. The LED is enclosed in an inner cover, and the inner cover is fitly seated in the outer mask to fill up the through hole on the housing, so that moisture and dust are prevented from entering into the housing via the through hole while the LED is accurately located in place in the through hole for easy observation thereof.

### FIELD OF THE INVENTION

The present invention relates to a portable storing device with USB, which is characterized by an inner cover enclosing an LED therein, and an outer mask fitted in a through hole provided on a housing of the storing device. With the inner cover firmly seated in the outer mask, moisture and dusk are prevented from entering the housing via the through hole, and the LED may be accurately located for easy observation thereof.

### BACKGROUND OF THE INVENTION

With the quick development of enhanced functions for computer, a computer not only provides surprisingly powerful operation ability, but also encounters with increasing demands for convenient storage of information and data. Data transfer among different computer systems may be achieved through network and many other ways, such as using the repeatedly recordable magneto optical (MO) to store and transfer data. However, the MO is currently not popular among computer users and is therefore not so convenient for use. Data may also be stored on an optical compact disc (CD). However, since the CD is not repeatedly recordable, and requires considerable time to record data thereon, it is not convenient for use, either. On the other hand, the use of universal serial bus (USB) interface and the development of storage chip or hard disk that has largely increased storage capacity and miniaturized size make portable storing devices widely adopted by consumers. Therefore, the portable storing devices are not only convenient for carrying and storing due to their small volume, but also highly useful in quick storing and transferring of data.

Generally, the portable storing devices may have differently designed appearances, but they usually include an LED mounted thereon to indicate a normal operation thereof during storing or reading data into or from the devices. The LED also reminds a user of a portable storing device in use, so as to avoid undesired unplugging of the operating portable storing device from a computer system that would reduce the usable life of the device.

FIGS. 1 and 2 illustrate a first conventional portable storing device that includes a housing 11 having a through hole 111 provided at a front end thereof, and a storage unit 12 mounted in the housing 11 with an LED 121 located in the through hole 111. It is noted the LED 121 does not tightly engage with the through hole 111, and moisture and dust tend to enter into a space defined between the housing 11 and a housing cap 13 via the through hole 111 to damage the storage unit 12. Moreover, the LED 121 is directly positioned in the through hole 111 without being accurately located in place, and is therefore easily movable due to an external force applied thereto. And, it is not easy to observe the indicating signal of the movable LED 121.

In an alternative case, the through hole 111 is formed corresponding to a diameter of the LED 121. In this case, it is time consuming to align the LED 121 with the through hole 111 during assembling of the device. Moreover, there is still a clearance 112 existed between an inner wall 111a of the through hole 111 and the LED 121, and moisture and dust tend to enter into the housing 11 via the clearance 112 to damage the storage unit 12. Dust deposited in the clearance 112 also tends to shield the LED 121 to reduce the brightness thereof, preventing the user to easily read the signal of the LED 121 indicating the operation of the portable storing device.

FIGS. 3 and 4 illustrate a second conventional portable storing device. As shown, the second conventional portable storing device includes a transparent sheet 24 provided in front of the through hole 211 of the housing 21. The LED 221 on the storage unit 22 is located at the through hole 211 having the transparent sheet 24 mounted thereto. Although the transparent sheet 24 is helpful in preventing the moisture and dust from entering into the space defined between the housing 21 and the housing cap 23 via the through hole 211, it is, however, useless in terms of accurate locating of the LED 221 in place. Moreover, the transparent sheet 24 tends to separate from the housing 21 due to an external force impacted thereon. Therefore, the transparent sheet 24 is functionally insufficient for protecting the portable storing device.

It is therefore tried by the inventor to develop a portable storing device with USB to eliminate the drawbacks existed in the conventional portable storing devices.

### SUMMARY OF THE INVENTION

A primary object of the present invention is to provide a portable storing device with USB, of which an LED may be accurately located in place.

Another object of the present invention is to provide a portable storing device with USB, which is effectively protected against a damaged storage unit due to moisture and dust entered into a housing thereof.

To achieve the above and other objects, the portable storing device with USB according to the present invention includes a housing being provided at a predetermined position with a through hole having an outer mask fitted therein; a housing cap being closed to an open end of the housing; and a storage unit being located in an inner space defined between the housing and the housing cap, and including a storage circuit board, a light emitting diode (LED), and a USB. The LED is enclosed in an inner cover, and the inner cover is fitly seated in the outer mask to fill up the through hole on the housing, so that moisture and dust are prevented from entering into the housing via the through hole while the LED is accurately located in place in the through hole for easy observation thereof.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded plan view of a conventional portable storing device showing the assembly thereof;

FIG. 2 is an assembled and partially sectioned plan view of the conventional portable storing device of FIG. 1;

FIG. 3 is an exploded plan view of another conventional portable storing device showing the assembly thereof;

FIG. 4 is an assembled and partially sectioned plan view of the conventional portable storing device of FIG. 3;

FIG. 5 is an exploded perspective view of a portable storing device according to a first embodiment of the present invention;

FIG. 6 is an exploded top plan view showing the assembly of the first embodiment of the present invention;

FIG. 7 is an assembled perspective view of FIG. 5;

FIG. 8 is an assembled and partially sectioned top plan view of the first embodiment of the present invention;

FIG. 9 is an exploded side view showing the assembly of the first embodiment of the present invention;

FIG. 10 is an assembled and partially sectioned side view of the first embodiment of the present invention;

FIG. 11 is an exploded side view showing the assembly of a second embodiment of the present invention; and

FIG. 12 is an assembled and partially sectioned side view of the second embodiment of the present invention

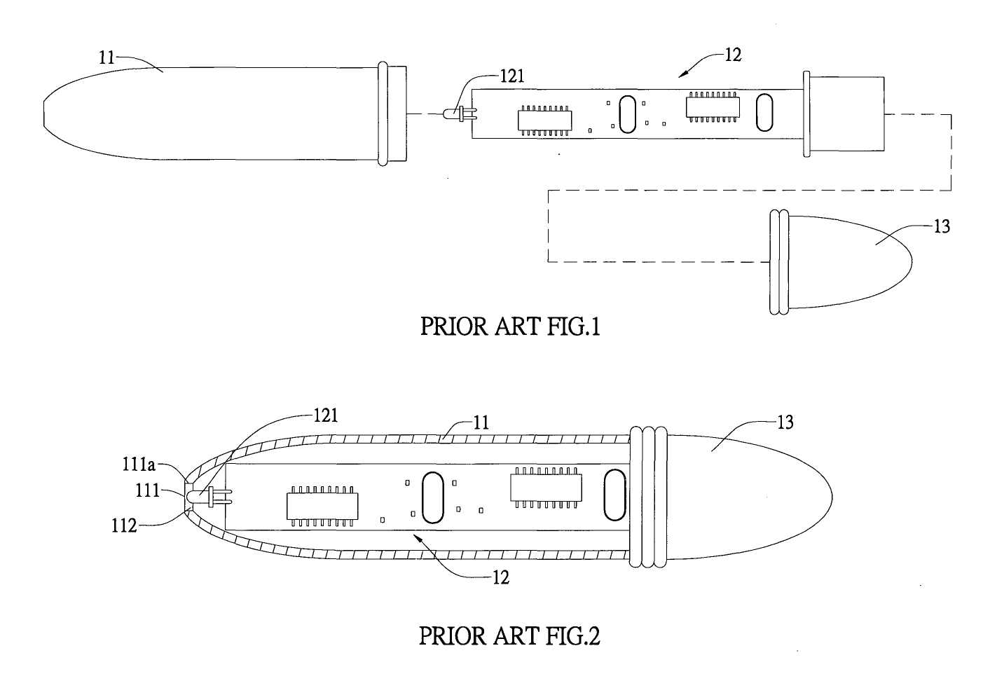

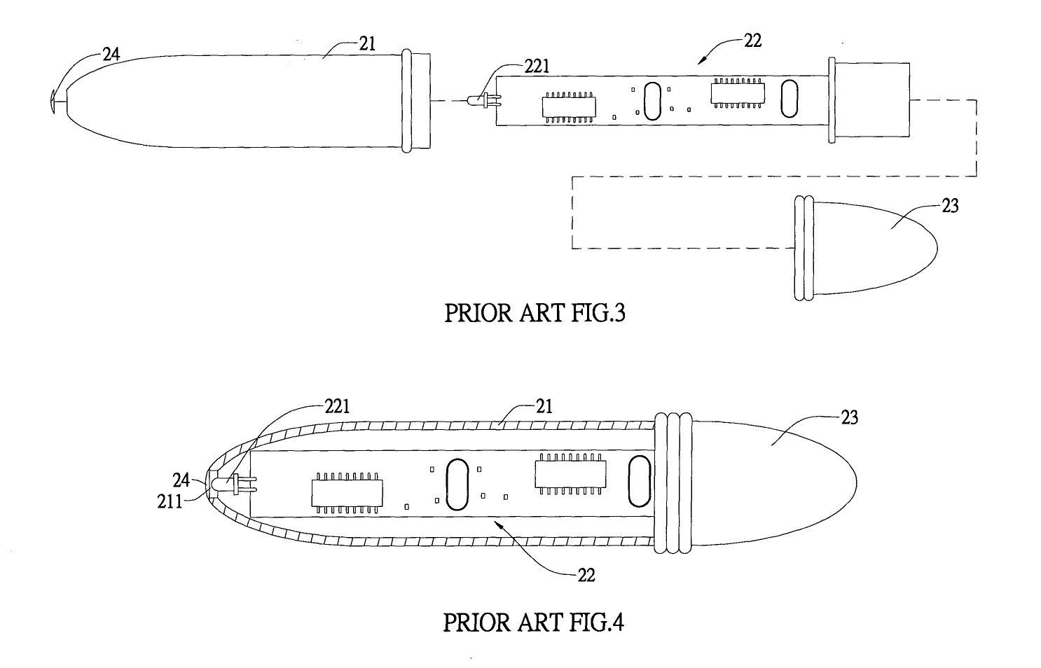

### DETAILED DESCRIPTION OF THE PREFERRED EMBODIMENTS

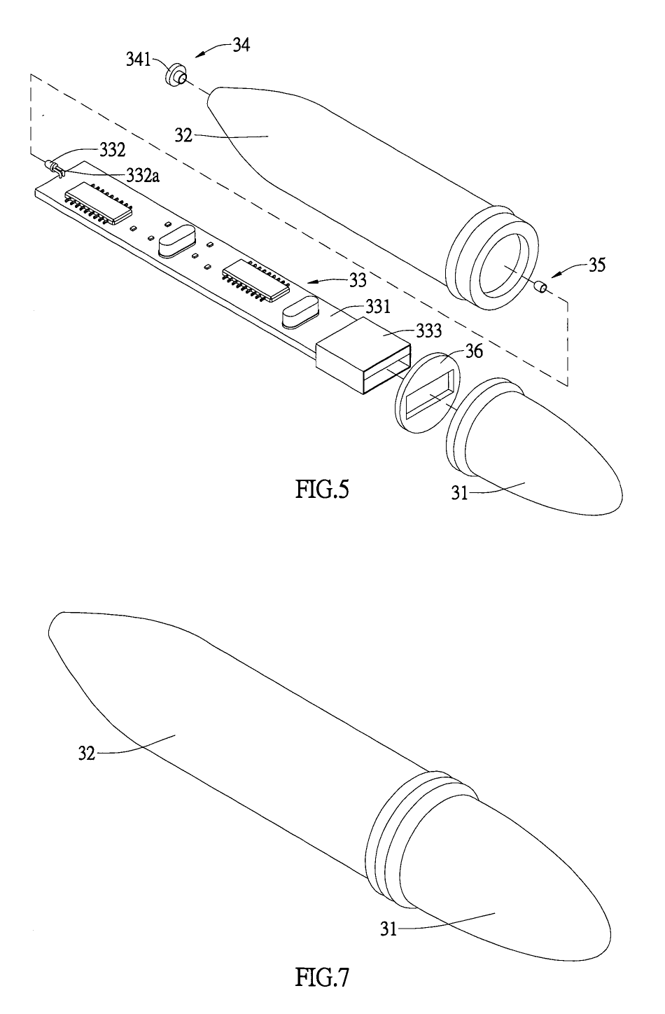

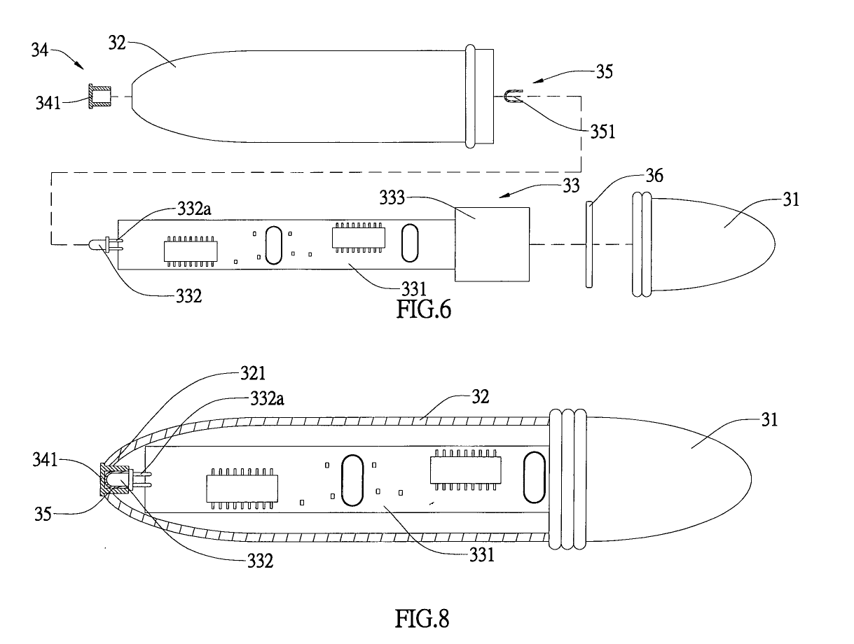

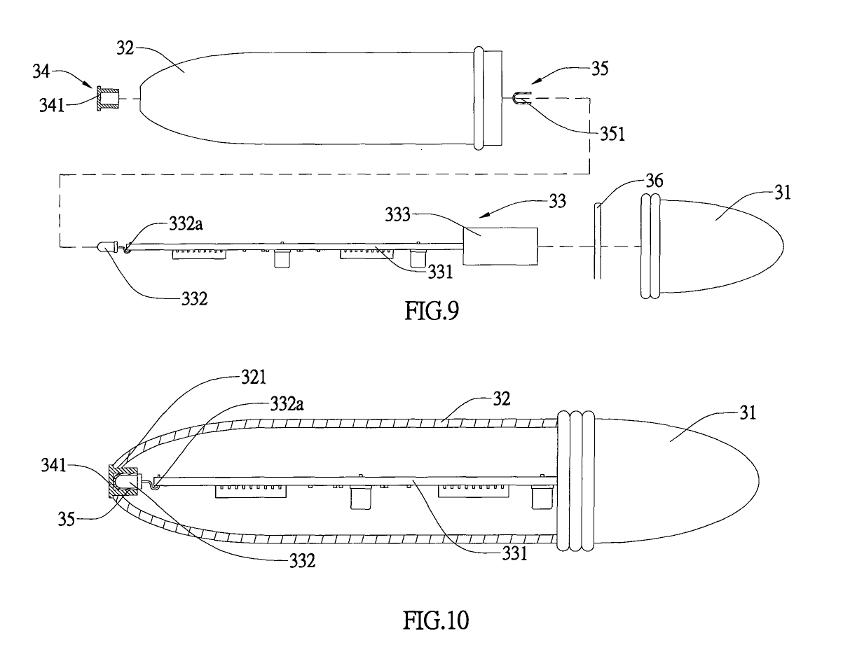

Please refer to FIGS. 5 through 10 in which a portable storing device with USB according to a first embodiment of the present invention is shown. As shown, the portable storing device with USB mainly includes a housing cap 31, a housing 32, a storage unit 33, an outer mask 34, an inner cover 35, and a disk-shaped locating member 36. The housing 32 is provided at front end with a through hole 321. The storage unit 33 includes a storage circuit board 331, a light-emitting diode (LED) 332, and a universal serial bus (USB) 333. The outer mask 34 includes a head portion 341 having an expanded diameter. The inner cover 35 defines a hollow space 351 therein. The locating member 36 serves to locate the storage unit 33 in place in the housing 32.

To assemble the portable storing device with USB, first fit the LED 332 in the hollow space 352 in the inner cover 35, and engage the USB 333 on the storage unit 33 with the locating member 36, so as to locate the storage unit 33 at a rear end of the housing 32. Then, fit the outer mask 34 in the through hole 321 at the front end of the housing 32, and position the storage unit 33 in the housing 32 with the inner cover 35 on the LED 332 fitly seated in the outer mask 34 without the risk of easily separating therefrom. Finally, connect the housing cap 31 to a rear open end of the housing 32 to enclose the storage unit 33 in a space defined between the housing 32 and the housing cap 31.

The outer mask 34 having the inner cover 35 seated therein is located in the through hole 321 on the housing 32 with the expanded head portion 341, which has a diameter larger than that of the through hole 321, closing the through hole 321 to prevent dust from entering into the housing 32 via the through hole 321. The mutually engaged outer mask 34 and inner cover 35 has an outer diameter the same as an inner bore of the through hole 321 to therefore stop moisture from enter into the housing 32 to damage the storage unit 33. The LED 332 is fixed in the through hole 321 via the inner cover 35, and can therefore be accurately located thereat for easy observation by a user.

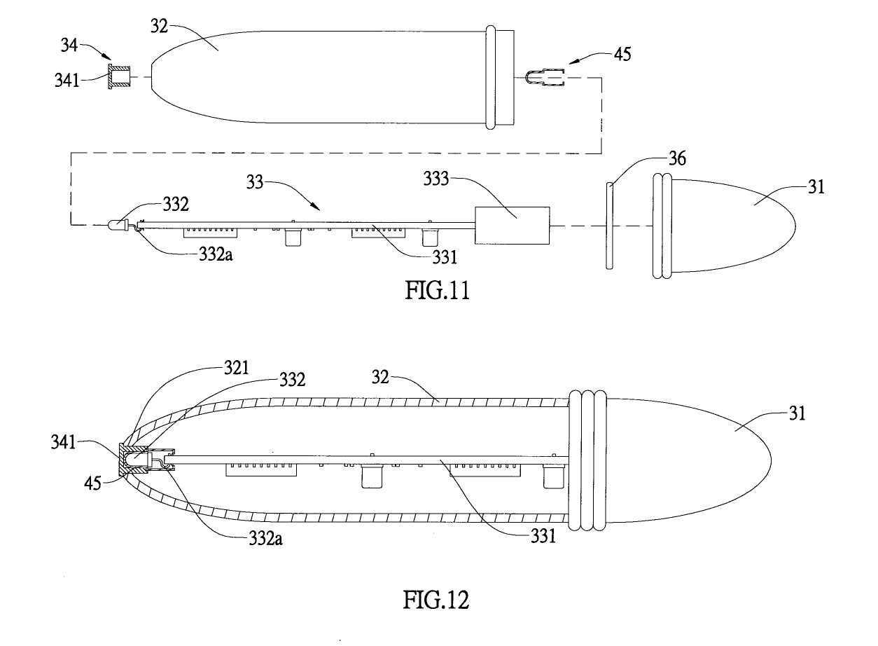

Please refer to FIGS. 11 and 12, in which a second embodiment of the present invention is shown. The second embodiment is generally structurally and functionally similar to that of the first embodiment, except that it includes an inner cover 45 adapted to receive the whole LED 332 therein and having an open end firmly connected to the storage circuit board 331 to protect pins 332a of the LED 332 against damage in the course of fitting the inner cover 45 into the outer mask 34.

The present invention has been described with some preferred embodiments thereof and it is understood that many changes and modifications in the described embodiments can be carried out without departing from the scope and the spirit of the invention as defined by the appended claims.

1. A portable storing device with universal serial bus, comprising:
a housing being provided at a predetermined position with a through hole, in which an outer mask is fitly mounted;
a housing cap being closed to an open end of said housing; and
a storage unit being located in an inner space defined between said housing and said housing cap, and including a storage circuit board, a light emitting diode (LED), and a universal serial bus (USB); and said LED being enclosed in an inner cover; and
said inner cover being fitly seated in said outer mask to fill up said through hole on said housing and thereby prevent moisture and dust from entering into said housing via said through hole while accurately locate said LED in place in said through hole for easy observation of said LED.

2. The portable storing device with universal serial bus as claimed in claim 1, wherein said LED is fully received in said inner cover, and said inner cover is fixedly connected at an open end to said storage circuit board.
